(19) United States
(12) Patent Application Publication
(10) Pub. No.: US 2019/0143685 A1
(43) Pub. Date: May 16, 2019

(54) LIQUID JET HEAD AND LIQUID JET RECORDING DEVICE

(71) Applicant: SII Printek Inc., Chiba-shi (JP)

(72) Inventors: Yuki YAMAMURA, Chiba-shi (JP); Masaru MIDORIKAWA, Chiba-shi (JP); Shuji SATO, Chiba-shi (JP); Shunsuke YAMAZAKI, Chiba-shi (JP); Naohiro TOMITA, Chiba-shi (JP)

(21) Appl. No.: 16/189,246

(22) Filed: Nov. 13, 2018

(30) Foreign Application Priority Data
Nov. 14, 2017 (JP) 2017-218699

(51) Int. Cl. B41J 2/14; B41J 2/16

(52) U.S. Cl. CPC B41J 2/1433; B41J 2/1609; B41J 2/1623; B41J 2/14209

(57) ABSTRACT

There is provided a liquid jet head capable of obtaining an excellent jet characteristic. The liquid jet head is provided with an actuator plate having a plurality of channels extending in a first direction, the plurality of channels filled with liquid, a nozzle plate disposed so as to be opposed to the actuator plate, and having a plurality of nozzle holes at positions corresponding to the plurality of channels, the liquid filled in the plurality of channels being jetted from the plurality of nozzle holes in a second direction crossing the first direction, and an intermediate plate disposed between the actuator plate and the nozzle plate, and having a plurality of slits extending in the first direction at positions corresponding respectively to the plurality of channels and the plurality of nozzle holes, a width of each of the plurality of slits in a third direction crossing each of the first direction and the second direction being larger than a width of each of the plurality of channels in the third direction.

### RELATED APPLICATIONS

This application claims priority under 35 U.S.C. § 119 to Japanese Patent Application No. 2017-218699 filed on Nov. 14, 2017, the entire content of which is hereby incorporated by reference.

### BACKGROUND OF THE INVENTION

### 1. Field of the Invention

The present disclosure relates to a liquid jet head for jetting a liquid, and a liquid jet recording device using the liquid jet head.

### 2. Description of the Related Art

As a recording device for recording an image, and so on, on a recording target medium, there is known a liquid jet recording device equipped with a liquid jet head.

In the liquid jet recording device, a liquid is jetted from the liquid jet head to the recording target medium to thereby record an image, and so on, on the recording target medium.

Regarding the configuration of the liquid jet recording device, there have been made a variety of studies. Specifically, in order to prevent a jet failure in a so-called edge-shoot type liquid jet head, an adhesive plate having a relief hole in a place corresponding to a nozzle hole is disposed between a nozzle plate and an actuator plate (see, e.g., JP-A-2009-292061). The outside diameter line of the relief hole is made distant at least a predetermined length from the outside diameter line of the nozzle hole.

Although a variety of studies have been made regarding the configuration of the liquid jet recording device equipped with the liquid jet head, the jet characteristic of the liquid jet head is not yet sufficient, and therefore has room for improvement.

Therefore, it is desired to provide a liquid jet head and a liquid jet recording device capable of obtaining an excellent jet characteristic.

### SUMMARY OF THE INVENTION

A liquid jet head according to an embodiment of the disclosure is provided with an actuator plate having a plurality of channels extending in a first direction, the plurality of channels filled with liquid, a nozzle plate disposed so as to be opposed to the actuator plate, and having a plurality of nozzle holes at positions corresponding to the plurality of channels, the liquid filled in the plurality of channels being jetted from the plurality of nozzle holes in a second direction crossing the first direction, and an intermediate plate disposed between the actuator plate and the nozzle plate, and having a plurality of slits extending in the first direction at positions corresponding respectively to the plurality of channels and the plurality of nozzle holes, a width of each of the plurality of slits in a third direction crossing each of the first direction and the second direction being larger than a width of each of the plurality of channels in the third direction.

A liquid jet recording device according to an embodiment of the disclosure is provided with a liquid jet head adapted to jet a liquid to a recording target medium, and a liquid storage section adapted to store the liquid, and the liquid jet head has substantially the same configuration as that of the liquid jet head according to the embodiment of the disclosure described above.

According to the liquid jet head and the liquid jet recording device related to the embodiment of the disclosure, since the intermediate plate is disposed between the actuator plate and the nozzle plate, and at the same time, the width of each of the slits provided to the intermediate plate is larger than the width of each of the channels provided to the actuator plate, an excellent jet characteristic can be obtained.

### BRIEF DESCRIPTION OF THE DRAWINGS

FIG. 1 is a perspective view showing a configuration of a liquid jet recording device (a liquid jet head) according to an embodiment of the disclosure.

FIG. 2 is a diagram schematically showing a configuration of the circulation mechanism shown in FIG. 1.

FIG. 3 is a perspective view showing respective configurations of a nozzle plate, an actuator plate, and a cover plate.

FIG. 4 is a plan view showing the configuration of the actuator plate shown in FIG. 3.

FIG. 5 is a plan view showing respective configurations of an intermediate plate and the actuator plate.

FIG. 6 is a cross-sectional view showing the respective configurations of the nozzle plate, the intermediate plate, the actuator plate and the cover plate along the line A-A shown in FIG. 4.

FIG. 7 is a cross-sectional view showing a part of the respective configurations of the nozzle plate, the intermediate plate and the actuator plate shown in FIG. 6 in an enlarged manner.

FIG. 8 is a cross-sectional view showing the respective configurations of the nozzle plate, the intermediate plate, the actuator plate and the cover plate along the line B-B shown in FIG. 4 in an enlarged manner.

FIG. 9 is a cross-sectional view showing a part of respective configurations of a nozzle plate and an actuator plate in a liquid jet recording device (a liquid jet head) of a first comparative example in an enlarged manner.

FIG. 10 is a cross-sectional view for explaining a problem of the liquid jet recording device of the first comparative example.

FIG. 11 is a cross-sectional view for explaining an advantage of the liquid jet recording device (the liquid jet head) according to the embodiment of the disclosure.

FIG. 12 is a cross-sectional view showing respective configurations of a nozzle plate, an intermediate plate, an actuator plate and a cover plate in a liquid jet recording device (a liquid jet head) of a second comparative example in an enlarged manner.

FIG. 13 is a cross-sectional view showing a modified example related to the configuration of the liquid jet head according to the embodiment of the disclosure.

### DETAILED DESCRIPTION OF THE PREFERRED EMBODIMENTS

An embodiment of the present disclosure will hereinafter be described in detail with reference to the drawings. It should be noted that the order of the descriptions is as follows.

1. Liquid Jet Recording Device (Liquid Jet Head)
1-1. Configuration of Liquid Jet Recording Device
1-2. Configuration of Liquid Jet Head
1-3. Respective Detailed Configurations of Nozzle Plate, Intermediate Plate, Actuator Plate and Cover Plate
1-4. Operations
1-5. Functions and Advantages

2. Modified Examples

### 1. LIQUID JET RECORDING DEVICE (LIQUID JET HEAD)

A liquid jet recording device of an embodiment of the present disclosure will be described.

It should be noted that the liquid jet head of the embodiment of the present disclosure is a part of the liquid jet recording device described here, and therefore, the liquid jet head will also be described below.

### <1-1. Configuration of Liquid Jet Recording Device>

Firstly, the configuration of the liquid jet recording device will be described.

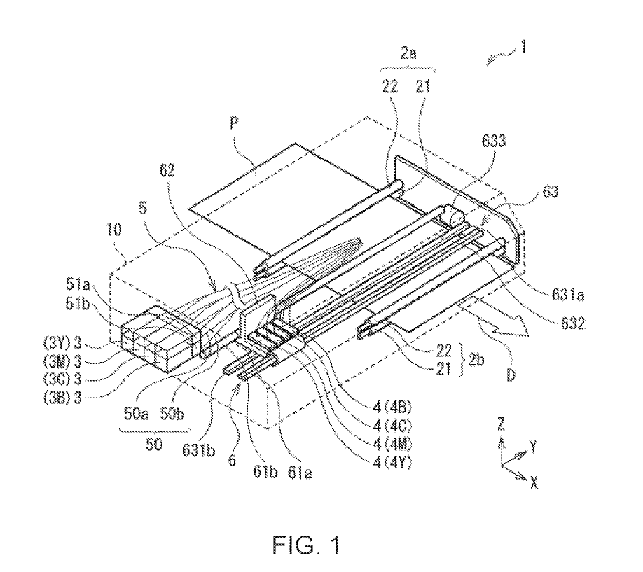

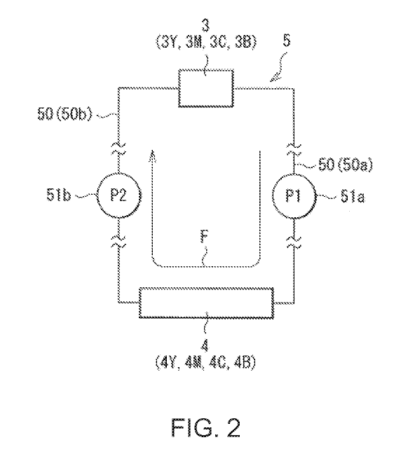

FIG. 1 shows a perspective configuration of a printer 1 as a specific example of the liquid jet recording device. FIG. 2 schematically shows a configuration of the circulation mechanism 5 shown in FIG. 1. It should be noted that in FIG. 1, the inside of a housing 10 is shown by representing an outer edge (contour) of the housing 10 using dotted lines.

This printer 1 is an inkjet type printer for mainly recording (printing) an image, and so on, on recording paper P as a recording target medium using ink 9 as a liquid for recording described later, and is a so-called inkjet printer.

In particular, the printer 1 described here is an inkjet printer of an ink circulation type using the ink 9 circulating in, for example, the circulation mechanism 5.

Specifically, as shown in FIG. 1 and FIG. 2, the printer 1 is provided with a pair of carrying mechanisms 2a, 2b, ink tanks 3, inkjet heads 4 as a specific example of the liquid jet head, the circulation mechanism 5, and a scanning mechanism 6 disposed inside the housing 10.

It should be noted that in FIG. 1 and FIG. 2 and the drawings described later, the scale size of each of the constituents is arbitrarily changed in order to convert the sizes of a series of constituents related to the printer 1 into recognizable sizes.

### [Carrying Mechanisms]

The pair of carrying mechanisms 2a, 2b are each a mechanism for mainly carrying the recording paper P having loaded into the printer 1 in a carrying direction D (an X-axis direction).

The carrying mechanisms 2a, 2b each include a grit roller 21 and a pinch roller 22 as shown in, for example, FIG. 1. The grit rollers 21 and the pinch rollers 22 each extend in, for example, a direction (a Y-axis direction) crossing the carrying direction D, and are each rotatable around the rotational axis extending in that direction. Further, the carrying mechanisms 2a, 2b are each connected to a drive mechanism such as a motor not shown, and each rotate using the power of the drive mechanism.

Here, the planar shape of the recording paper P is, for example, a rectangular shape defined by a pair of long sides opposed to each other, and a pair of short sides opposed to each other. Due to this configuration, the carrying direction D is, for example, a direction (the X-axis direction) along the longitudinal direction of the recording paper P, and at the same time, the direction crossing the carrying direction D is, for example, a direction (the Y-axis direction) along the short-side direction of the recording paper P.

### [Ink Tanks]

The ink tanks 3 are each a liquid storage section for mainly storing the ink 9.

The number of the ink tanks 3 is not particularly limited, and can therefore be just one, or two or more. Here, the printer 1 is provided with, for example, the four ink tanks 3 (3Y, 3M, 3C and 3B) for containing the ink 9 different in color from each other as shown in FIG. 1. The ink tanks 3Y, 3M, 3C and 3B are arranged in this order in, for example, the carrying direction D (the X-axis direction) from the upstream side toward the downstream side.

The ink tank 3Y stores, for example, the yellow (Y) ink 9. The ink tank 3M stores, for example, the magenta (M) ink 9. The ink tank 3C stores, for example, the cyan (C) ink 9. The ink tank 3Y contains, for example, the black (B) ink 9.

The ink tanks 3Y, 3M, 3C and 3B have substantially the same configurations except, for example, the fact that the types (colors) of the ink 9 are different from each other. Hereinafter, the ink tanks 3Y, 3M, 3C and 3B are collectively referred to as the “ink tanks 3” if necessary.

### [Inkjet Heads]

The inkjet heads 4 are each a device (head) for jetting the ink 9 to the recording paper P in order to mainly record an image, and so on, on the recording paper P. In this inkjet head 4, in particular, the ink 9 having a droplet form is jetted to the recording paper P.

The number of the inkjet heads 4 is not particularly limited, and can therefore be just one, or two or more. Here, the printer 1 is provided with, for example, the four inkjet heads 4 (4Y, 4M, 4C and 4B) for jetting the ink 9 different in color from each other in accordance with the four ink tanks 3 (3Y, 3M, 3C and 3B) described above as shown in FIG. 1. The inkjet heads 4Y, 4M, 4C and 4B are arranged in this order in, for example, a direction (the Y-axis direction) crossing the carrying direction D.

The inkjet head 4Y jets, for example, the yellow ink 9. The inkjet head 4M jets, for example, the magenta ink 9. The inkjet head 4C jets, for example, the cyan ink 9. The inkjet head 4B jets, for example, the black ink 9.

The inkjet heads 4Y, 4M, 4C and 4B have substantially the same configurations except, for example, the fact that the types (colors) of the ink 9 are different from each other. Hereinafter, the inkjet heads 4Y, 4M, 4C and 4B are collectively referred to as the “inkjet heads 4” if necessary.

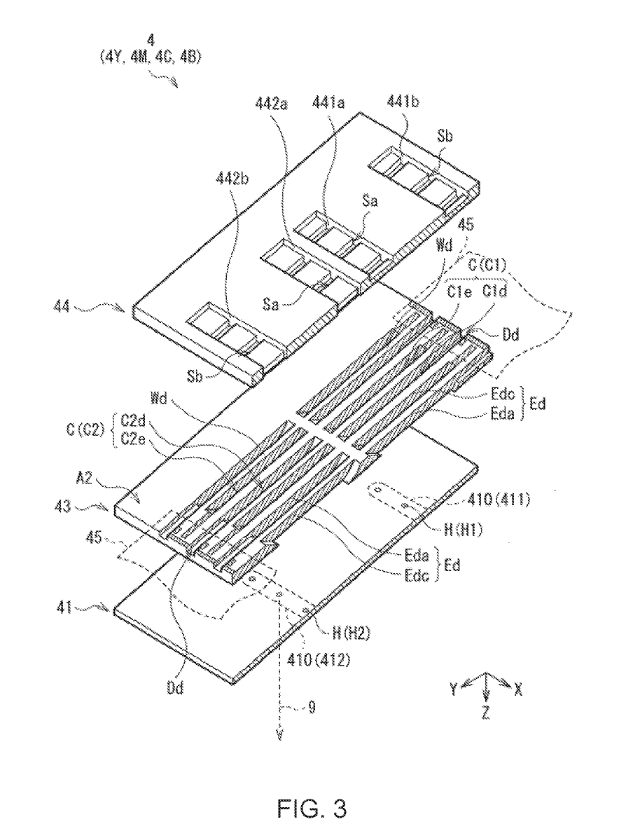

It should be noted that the detailed configuration of the inkjet head 4 will be described later (see FIG. 3 through FIG. 5).

### [Circulation Mechanism]

The circulation mechanism 5 is a mechanism for mainly circulating the ink 9 between the ink tanks 3 and the inkjet heads 4.

As shown in FIG. 2, the circulation mechanism 5 includes, for example, circulation channels 50 of the ink 9, pressure pumps 51a and suction pumps 51b.

The circulation channels 50 each include, for example, a first flow channel 50a through which the ink 9 flows from the ink tank 3 toward the inkjet head 4, and a second flow channel 50b through which the ink 9 flows from the inkjet head 4 toward the ink tank 3.

In each of the first flow channel 50a and the second flow channel 50b, for example, the ink 9 flows inside a tube, and the tube is, for example, a flexible tube having flexibility.

The pressure pump 51a is disposed in, for example, the first flow channel 50a. The pressure pump 51a pressurizes the inside of the first flow channel 50a to thereby supply the inkjet head 4 with the ink 9.

The suction pump 51b is disposed in, for example, the second flow channel 50b. The suction pump 51b reduces the pressure of the inside of the second flow channel 50b to thereby suction the ink 9 from the inkjet head 4.

Thus, in the circulation mechanism 5, for example, the ink 9 flows toward a circulation direction F. Specifically, the ink 9 having supplied from the ink tank 3 flows through, for example, the first flow channel 50a, the inkjet head 4 and the second flow channel 50b in this order to thereby return to the ink tank 3.

### [Scanning Mechanism]

The scanning mechanism 6 is a mechanism for mainly making the inkjet head 4 perform a scanning operation in a direction (the Y-axis direction) crossing the carrying direction D.

As shown in FIG. 1, the scanning mechanism 6 includes, for example, a pair of guide rails 61a, 61b, a carriage 62 and a drive mechanism 63.

The guide rails 61a, 61b each extend in, for example, a direction (the Y-axis direction) crossing the carrying direction D. The carriage 62 is, for example, supported by the guide rails 61a, 61b, and capable of moving in a direction (the Y-axis direction) crossing the carrying direction D along the guide rails 61a, 61b. The drive mechanism 63 includes, for example, a pair of pulleys 631a, 631b, an endless belt 632, and a drive motor 633.

The pair of pulleys 631a, 631b are disposed between, for example, the guide rails 61a, 61b. The pulleys 631a, 631b are disposed at, for example, positions corresponding respectively to the vicinities of the both ends of the guide rails 61a, 61b so as to extend in the Y-axis direction. The belt 632 is wound between, for example, the pulleys 631a, 631b. The belt 632 is connected to, for example, the carriage 62, and on the carriage 62, there is mounted, for example, the inkjet head 4.

By using the carrying mechanisms 2a, 2b and the scanning mechanism 6 as a moving mechanism, the recording paper P and the inkjet head 4 can move relatively to each other.

### <1-2. Configuration of Liquid Jet Head>

Then, a configuration of the inkjet heads 4 will be described.

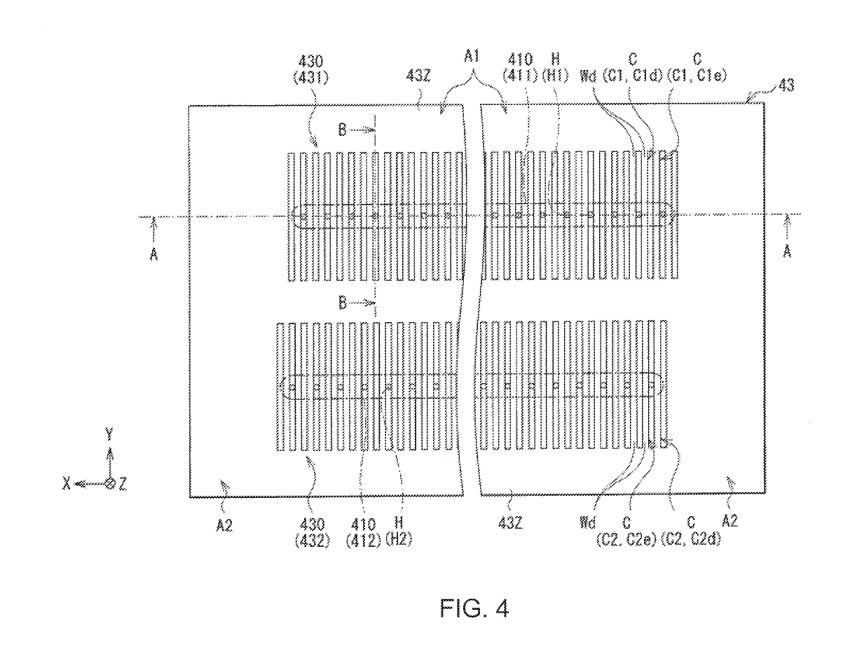

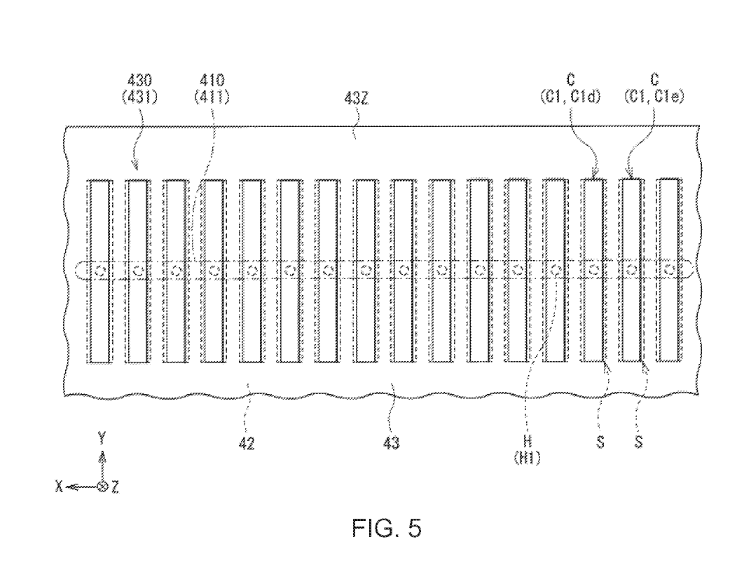

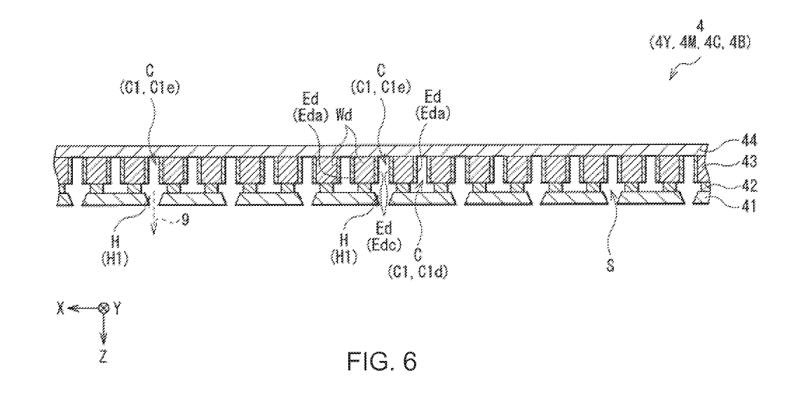

FIG. 3 shows respective perspective configurations of the nozzle plate 41, the actuator plate 43 and the cover plate 44. FIG. 4 shows a planar configuration of the actuator plate 43 shown in FIG. 3. FIG. 5 shows respective planar configurations of an intermediate plate 42 and the actuator plate 43. FIG. 6 shows respective cross-sectional configurations of the nozzle plate 41, the intermediate plate 42, the actuator plate 43 and the cover plate 44 along the line A-A shown in FIG. 4.

It should be noted that in FIG. 3, the illustration of the intermediate plate 42 is omitted, and at the same time, there is shown the state in which the nozzle plate 41, the actuator plate 43 and the cover plate 44 are separated from each other. Further, the nozzle columns 411, 412 (a plurality of nozzle holes H1, H2) are represented by dotted lines in FIG. 4, and at the same time, the nozzle column 411 (the plurality of nozzle holes H1) is represented by dotted lines in FIG. 5.

The inkjet head 4 described here is a so-called side-shoot type inkjet head. Specifically, in the inkjet head 4, for example, as described later, a plurality of channels C extending in the Y-axis direction (a first direction) is provided to the actuator plate 43, and the ink 9 is jetted from the plurality of nozzle holes H provided to the nozzle plate 41 in a Z-axis direction (a second direction) crossing the Y-axis direction.

In contrast, in a so-called edge-shoot type inkjet head, the jet direction of the ink 9 is different from that of the side-shoot type inkjet head 4 described above. Although not specifically illustrated here, in the edge-shoot type inkjet head, for example, a plurality of channels C extends in the Y-axis direction, and the ink 9 is jetted from the plurality of nozzle holes H in the Y-axis direction.

Further, the inkjet head 4 is, for example, a so-called circulation type inkjet head, and uses the ink 9 circulated between the ink tank 3 and the inkjet head 4 using the circulation mechanism 5 described above.

Specifically, as shown in FIG. 3 through FIG. 6, the inkjet head 4 is provided with, for example, the nozzle plate (a jet hole plate) 41, the intermediate plate 42, the actuator plate 43 and the cover plate 44.

The nozzle plate 41, the intermediate plate 42, the actuator plate 43 and the cover plate 44 each extend in, for example, a predetermined extending direction (the X-axis direction). The nozzle plate 41, the intermediate plate 42, the actuator plate 43 and the cover plate 44 are stacked on one another in this order toward, for example, a side (upper side in FIG. 3) far from the side from which the ink 9 is jetted.

### [Nozzle Plate]

The nozzle plate 41 is a plate mainly provided with a plurality of nozzle holes H as a jet orifice of the ink 9 described later.

The nozzle plate 41 is disposed so as to be opposed to the actuator plate 43 via the intermediate plate 42, and has the plurality of nozzle holes H at positions corresponding respectively to the plurality of channels C.

Further, the nozzle plate 41 includes, for example, any one type or two or more types of conductive materials, and has therefore conductivity. The types of the conductive materials are not particularly limited, but are metal materials such as stainless steel (SUS). This is because if the nozzle plate 41 includes a metal material, the metal material has high scratch resistance, and therefore, the physical strength of the nozzle plate 41 is improved. It should be noted that the types of SUS are not particularly limited, but are, for example, SUS316L and SUS304.

Specifically, the nozzle plate 41 has, for example, a plurality of nozzle columns 410 arranged at a predetermined distance in the Y-axis direction as shown in FIG. 3 through FIG. 6. The nozzle columns 410 each extend in, for example, the X-axis direction, and each include the plurality of nozzle holes H. The opening shape (the shape of the nozzle hole H viewed from the Z-axis direction) of the nozzle hole H is, for example, a circular shape.

Here, the nozzle plate 41 has, for example, two nozzle columns 410 (411, 412). Therefore, the inkjet head 4 is, for example, a so-called two-column type inkjet head.

The nozzle column 411 includes, for example, the plurality of nozzle holes H1 arranged at predetermined intervals in the X-axis direction. The nozzle holes H1 each extend in the Z-axis direction so as to penetrate the nozzle plate 41, and are communicated with the respective jet channels C1e of the actuator plate 43 described later. Further, the nozzle holes H1 are each located at a position corresponding to a roughly central area of the jet channel C1e extending in the Y-axis direction. The pitch (the distance between the two nozzle holes H1 adjacent to each other) of the plurality of nozzle holes H1 in the X-axis direction is substantially the same as, for example, the pitch (the distance between the two jet channels C1e adjacent to each other) of the plurality of jet channels C1e in the X-axis direction. Thus, the ink 9 supplied from the jet channels C1e is jetted from the respective nozzle holes H1.

The nozzle column 412 has substantially the same configuration as that of, for example, the nozzle column 411 described above. Specifically, the nozzle column 412 includes, for example, the plurality of nozzle holes H2 arranged at predetermined intervals in the X-axis direction. The nozzle holes H2 each penetrate the nozzle plate 41, and are communicated with the respective jet channels C2e of the actuator plate 43 described later. Further, the nozzle holes H2 are each located at a position corresponding to a roughly central area of the jet channel C2e extending in the Y-axis direction. The pitch (the distance between the two nozzle holes H adjacent to each other) of the plurality of nozzle holes H2 in the X-axis direction is substantially the same as, for example, the pitch (the distance between the two jet channels C2e adjacent to each other) of the plurality of jet channels C2e in the X-axis direction. Thus, the ink 9 supplied from the jet channels C2e is jetted from the respective nozzle holes H2.

The direction in which the ink 9 is jetted from each of the nozzle holes H1, H2 is the direction (the Z-axis direction) crossing the extending direction (the Y-axis direction) of the plurality of channels C as described above. More specifically, the jet direction of the ink 9 is a direction (the downward direction in FIG. 3) from the actuator plate 43 toward the nozzle plate 41. The inner diameter of each of the nozzle holes H1, H2 gradually decreases in a direction toward, for example, the jet direction. In other words, each of the nozzle holes H1, H2 is, for example, a penetration orifice having a tapered shape.

### [Intermediate Plate]

The intermediate plate 42 is a plate which mainly intervenes between the nozzle plate 41 and the actuator plate 42 to thereby be used for aligning the nozzle plate 41 and the actuator plate 43 with each other.

The intermediate plate 42 includes, for example, any one type or two or more types of insulating materials, and therefore has an insulation property. The types of the insulating materials are not particularly limited, but are polymer materials such as polyimide and poly-paraxylene (so-called parylene).

The nozzle plate 41 and the actuator plate 43 are bonded to each other via, for example, the intermediate plate 42. Thus, the nozzle plate 41 having conductivity and the actuator plate 43 having conductivity are electrically separated (insulated) from each other via, for example, the intermediate plate 42 having an insulation property. This is because if the nozzle plate 41 and the actuator plate 43 are insulated from each other via the intermediate plate 42, it becomes possible to use a conductive material as the constituent material of the nozzle plate 41, and at the same time, it becomes possible to use a piezoelectric material as the constituent material of the actuator plate 43, and therefore, in particular, it becomes possible to use a metal material or the like having high scratch resistance as the constituent material of the nozzle plate 41. Thus, it becomes difficult for the nozzle plate 41 to be damaged (e.g., worn) while preventing the short circuit between the nozzle plate 41 and the actuator plate 43.

In particular, it is preferable for the intermediate plate 42 to have an intermediate linear expansion coefficient E1 between the linear expansion coefficient E2 of the nozzle plate 41 and the linear expansion coefficient E3 of the actuator plate 43 (E2<E1<E3 or E3<E1<E2). This is because if the linear expansion coefficients E1 through E3 satisfy the relationship described above, when each of the nozzle plate 41, the intermediate plate 42 and the actuator plate 43 deforms thermally, the displacement of each of the nozzle plate 41 and the actuator plate 43 due to the difference in linear expansion coefficient (thermal expansion coefficient) is absorbed by the intermediate plate 42. Thus, the separation between the nozzle plate 41 and the actuator plate 43 due to the thermal deformation is suppressed compared to the case in which the intermediate plate 42 does not intervene between the nozzle plate 41 and the actuator plate 43. Therefore, it becomes difficult for the failure such as deflection to occur when jetting the ink 9.

Specifically, the intermediate plate 42 has, for example, a plurality of slits S at positions corresponding to the plurality of channels C and the plurality of nozzle holes H as shown in FIG. 5 and FIG. 6. Similarly to the channels C, for example, the slits S extend in the Y-axis direction, and are, at the same time, arranged in the X-axis direction at predetermined intervals.

It should be noted that the thickness of the intermediate plate 42 is not particularly limited, but in particular, it is preferable for the thickness not to be excessively large. This is because if the thickness of the intermediate plate 42 is not excessively large, it becomes difficult for the thickness of the intermediate plate 42 to affect the supply of the ink 9 to the nozzle holes H, and therefore, it becomes easy for the ink 9 to stably be supplied to the nozzle holes H. Specifically, the thickness of the intermediate plate 42 is, for example, equal to or smaller than 25 μm.

### [Actuator Plate]

The actuator plate 43 is a plate electrically operating mainly for jetting the ink 9 from the plurality of nozzle holes H.

As described above, the actuator plate 43 has the plurality of channels C each extending in the Y-axis direction. The opening shape (the shape of the channel C viewed from the Z-axis direction) of the channel C is, for example, a rectangular shape. Since each of the channels C is filled with the ink 9, the ink 9 is jetted from each of the nozzles H.

Further, the actuator plate 43 includes, for example, any one type or two or more types of piezoelectric materials. The types of the piezoelectric materials are not particularly limited, but are, for example, lead zirconium titanate (PZT). The actuator plate 43 is, for example, a stacked body having two piezoelectric substrates stacked on one another, the two piezoelectric substrate being configured so that the respective polarization directions in the Z-axis direction are different from each other (a so-called chevron type).

It should be noted that the configuration of the actuator plate 43 is not limited to the chevron type described above. Specifically, the actuator plate 43 can also be, for example, a single piezoelectric substrate which is configured so that the polarization direction in the Z-axis direction is one direction (a so-called cantilever type).

Specifically, the actuator plate 43 has, for example, a plurality of channel columns 430 arranged at a predetermined distance in the Y-axis direction as shown in FIG. 3 through FIG. 6. The channel columns 430 each extend in, for example, the X-axis direction, and each include the plurality of channels C. Here, the actuator plate 43 has, for example, the two channel columns 430 (431, 432).

In the actuator plate 43, for example, a jet area A1 of the ink 9 is disposed in roughly the central area (an area where the channel columns 431, 432 are formed) in the X-axis direction, and at the same time, non-jet areas A2 of the ink 9 are disposed in both end areas (the areas where the channel columns 431, 432 are not formed) in the X-axis direction. In other words, the non-jet areas A2 are disposed on the outer side of the jet area A1 in the X-axis direction. It should be noted that both end parts of the actuator plate 43 in the Y-axis direction are each a so-called tail part 43Z.

The channel column 431 includes, for example, a plurality of channels C1 extending in the Y-axis direction. The plurality of channels C1 is, for example, arranged at predetermined intervals in the X-axis direction. Each of the channels C1 is partitioned by, for example, drive walls Wd each including a piezoelectric body.

The channel column 432 has substantially the same configuration as that of, for example, the channel column 431 described above. Specifically, the channel column 432 includes, for example, a plurality of channels C2 extending in the Y-axis direction. The plurality of channels C2 is, for example, arranged at predetermined intervals in the X-axis direction. Each of the channels C2 is partitioned by, for example, the drive walls Wd each including a piezoelectric body.

The plurality of channels C1 includes, for example, the jet channels C1e for jetting the ink 9 and dummy channels C1d not jetting the ink 9. In the channel column 431, the jet channels C1e and the dummy channels C1d are alternately arranged along the X-axis direction, for example. The jet channels C1e are communicated with the respective nozzle holes H1 provided to the nozzle plate 41. In contrast, the dummy channels C1d are not communicated with the respective nozzle holes H1, but are shielded by the nozzle plate 41.

The plurality of channels C2 has substantially the same configuration as that of, for example, the plurality of channels C1 described above. Specifically, the plurality of channels C2 includes, for example, the jet channels C2e for jetting the ink 9 and dummy channels C2d not jetting the ink 9. In the channel column 432, the jet channels C2e and the dummy channels C2d are alternately arranged along the X-axis direction, for example. The jet channels C2e are communicated with the respective nozzle holes H2 provided to the nozzle plate 41. In contrast, the dummy channels C2d are not communicated with the respective nozzle holes H2, but are shielded by the nozzle plate 41.

The jet channels C1e and the dummy channels C1d, and the jet channels C2e and the dummy channels C2d are arranged in a staggered manner, for example. In other words, the jet channels C1e, C2e are arranged in a zigzag manner, for example. It should be noted that in the actuator plate 43, in each of the areas corresponding respectively to the dummy channels C1d, C2d, there is disposed, for example, a shallow groove section Dd. The shallow groove section Dd is communicated with an outside end part of each of the dummy channels C1d, C2d extending in the Y-axis direction, for example.

In the actuator plate 43, for example, drive electrodes Ed extending in the Y-axis direction are disposed on inner side surfaces opposed to the drive walls Wd. The drive electrodes Ed include, for example, common electrodes Edc disposed on the respective inner side surfaces of the jet channels C1e, C2e, and active electrodes Eda disposed on the respective inner side surfaces of the dummy channels C1d, C2d. It should be noted that the drive electrodes Ed (the common electrodes Edc and the active electrodes Eda) each extend from one end part of the actuator plate 43 (the drive wall Wd) to the other end part in the Z-axis direction. Therefore, the dimension (the height) of the drive electrode Ed in the Z-axis direction is made roughly equal to, for example, the dimension (the height) of the drive wall Wd in the Z-axis direction.

The pair of common electrodes Edc opposed to each other inside one jet channel C1e (or one jet channel C2e) are, for example, electrically connected to each other via a common terminal. Further, the pair of active electrodes Eda opposed to each other inside one dummy channel C1d (or one dummy channel C2d) are, for example, electrically separated from each other. The pair of active electrodes Eda opposed to each other via the jet channel C1e (or the jet channel C2e) are, for example, electrically connected to each other via an active terminal.

In the tail part 43Z, for example, there is mounted a flexible printed circuit board 45 for electrically connecting the drive electrodes Ed and the inkjet head 4 to each other. It should be noted that in FIG. 3, outer edges (contours) of some parts of the flexible printed circuit board 45 are represented by the dotted lines. Interconnections provided to the flexible printed circuit board 45 are electrically connected to, for example, the common terminals and the active terminals described above, respectively. Thus, the drive voltage is applied to each of the drive electrodes Ed from the inkjet head 4 via the flexible printed circuit board 45.

### [Cover Plate]

The cover plate 44 is a plate for mainly introducing the ink 9 into the actuator plate 43 (the plurality of channels C), and at the same time discharging the ink 9 from the actuator plate 43. The actuator plate 43 is disposed between the intermediate plate 42 and the cover plate 44.

The cover plate 44 includes, for example, substantially the same material as the constituent material of the actuator plate 43.

Specifically, as shown in FIG. 3 through FIG. 6, the cover plate 43 is disposed so as to shield the plurality of channels C1, C2 (the plurality of channel columns 431, 432) provided to the actuator plate 43.

The cover plate 44 has, for example, a pair of entrance side common ink chambers 441a, 442a and a pair of exit side common ink chambers 441b, 442b. The entrance side common ink chamber 441a and the exit side common ink chamber 441b are each disposed in, for example, an area corresponding to the channel column 431 (the plurality of channels C1) provided to the actuator plate 43. The entrance side common ink chamber 442a and the exit side common ink chamber 442b are each disposed in, for example, an area corresponding to the channel column 432 (the plurality of channels C2) provided to the actuator plate 43.

The entrance side common ink chamber 441a is an introduction opening for the ink 9 disposed at a position corresponding to one end part (an inside end part) of each of the channels C1 extending in the Y-axis direction, and the ink 9 is introduced into each of the channels C1 via the entrance side common ink chamber 441a. In the entrance side common ink chamber 441a, in an area corresponding to each of the jet channels C1e, there is formed, for example, a supply slit Sa. Further, the entrance side common ink chamber 442a is an introduction opening for the ink 9 disposed at a position corresponding to one end part (an inside end part) of each of the channels C2 extending in the Y-axis direction, and the ink 9 is introduced into each of the channels C2 via the entrance side common ink chamber 442a. In the entrance side common ink chamber 442a, in an area corresponding to each of the jet channels C2e, there is formed, for example, the supply slit Sa similarly to the entrance side common ink chamber 441a described above.

The exit side common ink chamber 441b is a discharge opening for the ink 9 disposed at a position corresponding to the other end part (an outside end part) of each of the channels C1 extending in the Y-axis direction, and the ink 9 is discharged from each of the channels C1 via the exit side common ink chamber 441b. In the exit side common ink chamber 441b, in an area corresponding to each of the jet channels C1e, there is formed, for example, a discharge slit Sb. Further, the exit side common ink chamber 442b is a discharge opening for the ink 9 disposed at a position corresponding to the other end part (an outside end part) of each of the channels C2 extending in the Y-axis direction, and the ink 9 is discharged from each of the channels C2 via the exit side common ink chamber 442b. In the exit side common ink chamber 442b, in an area corresponding to each of the jet channels C2e, there is formed, for example, the discharge slit Sb similarly to the exit side common ink chamber 441b described above.

The entrance side common ink chamber 441a and the exit side common ink chamber 441b are each communicated with each of the jet channels C1e via the supply slit Sa and the discharge slit Sb on the one hand, but are not communicated with each of the dummy channels C1d on the other hand. Specifically, each of the dummy channels C1d is shielded by the entrance side common ink chamber 441a and the exit side common ink chamber 441b.

The entrance side common ink chamber 442a and the exit side common ink chamber 442b are each communicated with each of the jet channels C2e via the supply slit Sa and the discharge slit Sb on the one hand, but are not communicated with each of the dummy channels C2d on the other hand. Specifically, each of the dummy channels C2d is shielded by the entrance side common ink chamber 442a and the exit side common ink chamber 442b.

### <1-3. Respective Detailed Configurations of Nozzle Plate, Intermediate Plate, Actuator Plate and Cover Plate>

Then, the respective detailed configurations of the nozzle plate 41, the intermediate plate 42, the actuator plate 43 and the cover plate 44 will be described. The positional relationship is hereinafter described together with the detailed configurations.

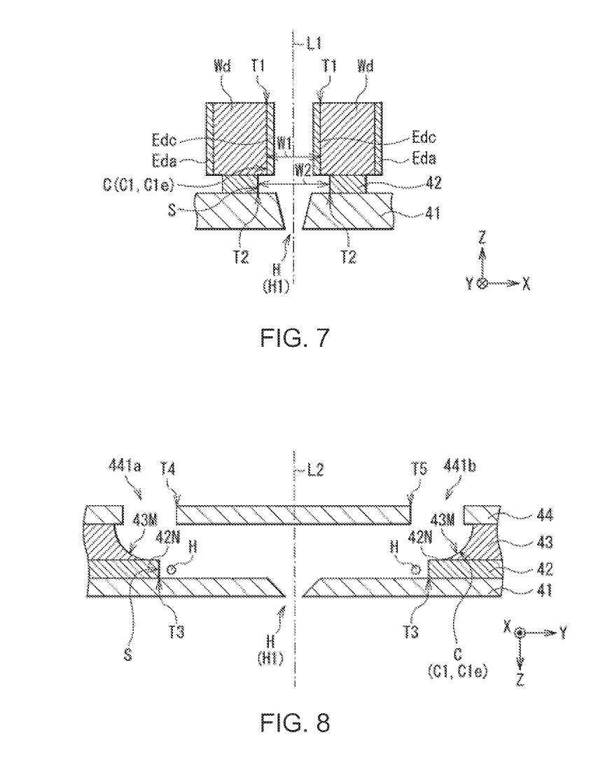

In FIG. 7, a part of the respective cross-sectional configurations of the nozzle plate 41, the intermediate plate 42 and the actuator plate 43 shown in FIG. 6 is enlarged. In FIG. 8, the respective cross-sectional configurations of the nozzle plate 41, the intermediate plate 42, the actuator plate 43 and the cover plate 44 along the line B-B shown in FIG. 4 are enlarged.

Hereinafter, a dimension in a direction (the X-axis direction) crossing each of the extending direction (the Y-axis direction) of the plurality of channels C and the jet direction (the Z-axis direction) of the ink 9 is defined as “width.” Further, the extending direction (the Y-axis direction) of the plurality of channels C described above is defined as a “length direction.”

### [Respective Configurations of and Positional Relationship Between Intermediate Plate and Actuator Plate]

As shown in FIG. 6 and FIG. 7, the width W1 is common to, for example, the plurality of channels C (C1e), and at the same time, the width W2 is common to, for example, the plurality of slits S.

It should be noted that the “width W1” described here is not the length between the two common electrodes Edc adjacent to each other, but is the width of the channel C. That is, the width W1 should technically be defined based on the distance between the two common electrodes Edc adjacent to each other instead of the distance between the two drive walls Wd adjacent to each other. However, since the thickness of each of the common electrodes Edc is sufficiently small with respect to the distance between the two drive walls Wd adjacent to each other, the thickness of each of the common electrodes Edc hardly affects the distance between the two drive walls Wd adjacent to each other. Therefore, the “width W1” is defined based on the distance between the two drive walls Wd adjacent to each other as described above.

In this case, as shown in FIG. 7, the width W2 of each of the slits S is made larger than the width W1 of each of the channels C. This is because if the width W2 is larger than the width W1, it becomes difficult for the supply route of the ink 9 supplied from the channel C to the nozzle hole H to be hindered by the actuator plate 43, and therefore, it becomes difficult for the problem (e.g., the deflection of the jet direction of the ink 9) related to the jet characteristic of the ink 9 to occur. The detailed reason that the problem becomes difficult to occur will be described later.

Here, providing the slit S is disposed at the position corresponding to each of the channel C and the nozzle hole H, the positional relationship between the channel C and the slit S is not particularly limited. In particular, it is preferable for the channel C to be disposed inside the area defined by the width W2 of the slit S. This is because if the channel C is disposed in the area defined by the width W2 of the slit S, it becomes more difficult for the supply of the ink 9 to the nozzle hole H to be hindered.

In detail, the actuator plate 43 has, for example, two inside end parts T1 (first inside end parts) for defining the channel C in the X-axis direction. Further, the intermediate plate 42 has, for example, two inside end parts T2 (second inside end parts) for defining the slit S in the X-axis direction.

The “inner side” described here is a side closer to the center (a center line L1) than to each of the left end and the right end in the X-axis direction (the lateral direction) shown in FIG. 7. Further, a side in the opposite direction, namely a side closer to each of the left end and the right end than to the center line L1, is the “outer side.”

In this case, it is preferable for each of the two inside end parts T2 to be located on the outer side of each of the two inside end parts T1 in the X-axis direction. In other words, it is preferable that the inside end part T2 is located on the outer side of the inside end part T1 in the right area of the center line L1, and at the same time, the inside end part T2 is located on the outer side of the inside end part T1 in the left area of the center line L1.

Thus, it results that the inside end parts T1 for defining the channel C are located on the inner side of the inside end parts T2 for defining the slit S. Therefore, as described above, the channel C is disposed inside the area defined by the width W2 of the slit S. The “area” is an area located between the two inside end parts T2 in the X-axis direction.

### [Respective Configurations of and Positional Relationship Between Intermediate Plate and Cover Plate]

As shown in FIG. 7 and FIG. 8, the slit S extends in the Y-axis direction. Further, in the cover plate 44, there is disposed the entrance side common ink chamber 441a at the position corresponding to the one end part of the channel C (C1e) extending in the Y-axis direction, and at the same time, there is disposed the exit side common ink chamber 441b at the position corresponding to the other end of the channel C (C1e). It should be noted that an inner wall surface 43M of the actuator plate 43 for defining the channel C is curved so as to, for example, gradually come closer to the nozzle hole H in a direction from the cover plate 44 toward the intermediate plate 42.

In this case, it is preferable for the slit S to extend from a position inside the area corresponding to the entrance side common ink chamber 441a to a position inside the area corresponding to the exit side common ink chamber 441b as shown in FIG. 8. This is because if the slit S extends in such a manner as described above, even in the case in which a bubble H occurs inside the slit S, it becomes difficult for the bubble to be retained inside the slit S, and therefore, it becomes difficult for the jet failure of the ink 9 to occur. The detailed reason that the jet failure becomes difficult to occur will be described later.

In detail, the intermediate plate 42 has, for example, two inside end parts T3 (third inside end parts) for defining the slit S in the Y-axis direction. Further, the cover plate 44 has, for example, an inside end part T4 (a fourth inside end part) for defining the entrance side common ink chamber 441a in the Y-axis direction, and an inside end part T5 (a fifth inside end part) for defining the exit side common ink chamber 441b in the Y-axis direction.

The “inner side” described here is a side closer to the center (a center line L2) than to each of the left end and the right end in the Y-axis direction (the lateral direction) shown in FIG. 8. Further, a side in the opposite direction, namely a side closer to each of the left end and the right end than to the center line L2, is the “outer side.”

In this case, it is preferable for each of the two inside end parts T3 to be located on the outer side of each of the inside end parts T4, T5 in the X-axis direction. In other words, it is preferable that the inside end part T3 is located on the outer side of the inside end part T4 in the left area of the center line L2, and at the same time, the inside end part T3 is located on the outer side of the inside end part T5 in the right area of the center line L2.

Thus, as a result, one of the two inside end parts T3 defining the slit S is located inside the area corresponding to the entrance side common ink chamber 441a, and at the same time, the other of the inside end parts T3 is located inside the area corresponding to the exit side common ink chamber 441b. Therefore, the slit S extends from the position inside the area corresponding to the entrance side common ink chamber 441a to the position inside the area corresponding to the exit side common ink chamber 441b as described above. The “area corresponding to the entrance side common ink chamber 441a” is an area overlapping the entrance side common ink chamber 441a in the Z-axis direction, and at the same time, the “area corresponding to the exit side common ink chamber 441b” is an area overlapping the exit side common ink chamber 441b in the Z-axis direction.

### <1-4. Operations>

Then, the operations of the printer 1 will be described.

### [Operations of Printer]

Firstly, an overall operation of the printer 1 will be described. In this printer 1, an image and so on are recorded on the recording paper P in the following procedure.

In the initial state, the ink 9 of the four colors (yellow, magenta, cyan and black) different from each other are respectively housed in the four ink tanks 3 (3Y, 3M, 3C and 3B). The ink 9 is circulated in the circulation mechanism 5 to thereby be supplied to the inkjet head 4.

When the printer 1 operates, the grit rollers 21 of the respective carrying mechanisms 2a, 2b rotate, and therefore, the recording paper P is carried in the carrying direction D due to the grit rollers 21 and the pinch rollers 22. In this case, due to the drive of the drive mechanism 63 (the drive motor 633), the pulleys 631a, 631b rotate to thereby operate the belt 632. Further, the carriage 62 reciprocates in the Y-axis direction using the guide rails 61a, 61b. Thus, since the four colors of ink 9 are jetted from the four inkjet heads 4 (4Y, 4M, 4C and 4B) to the recording paper P, the image and so on are recorded on the recording paper P.

### [Operations of Inkjet Heads]

Then, the operations of the inkjet heads 4 when the printer 1 is in operation will be described. In each of the inkjet heads 4, the ink 9 is jetted to the recording paper P using a shear mode in the following procedure.

Firstly, when the carriage 62 reciprocates, the drive voltages are applied to the drive electrodes Ed (the common electrodes Edc and the active electrodes Eda) in the inkjet head 4 via the flexible printed circuit board 45. Specifically, the drive voltage is applied to the respective drive electrodes Ed provided to the pair of drive walls Wd defining the jet channel C1e, C2e. Thus, the pair of drive walls Wd each deform so as to protrude toward the dummy channel C1d, C2d adjacent to the jet channel C1e, C2e.

Here, as described above, in the actuator plate 43, the two piezoelectric substrates configured so that the polarization directions in the Z-axis direction are different from each other are stacked on one another, and at the same time, the drive electrodes Ed extend in the Z-axis direction from one end part of the drive walls Wd to the other end part. In this case, by applying the drive voltage to the drive electrodes Ed, the drive wall Wd makes flexural deformation taking a roughly middle position of the drive wall Wd in the Z-axis direction as an origination due to the piezoelectric thickness-shear effect. Thus, each of the jet channels C1e, C2e deforms as if it bulges using the flexural deformation of the drive wall Wd described above.

The capacity of each of the jet channels C1e, C2e increases using the flexural deformation of the pair of drive walls Wd based on the piezoelectric thickness-shear effect. Thus, the ink 9 having retained in each of the entrance side common ink chambers 441a, 442a is induced into the inside of each of the jet channels C1e, C2e.

Subsequently, the ink 9 having been induced into the inside of each of the jet channels C1e, C2e propagates to the inside of each of the jet channels C1e, C2e as a pressure wave. In this case, the drive voltage to be applied to the drive electrodes Ed becomes zero (0 V) at the timing at which the pressure wave has reached the nozzle hole H1, H2 provided to the nozzle plate 41. Thus, the drive walls Wd having flexurally deformed are restored to the original state, and therefore, the capacity of each of the jet channels C1e, C2e is restored.

Lastly, when the capacity of each of the jet channels C1e, C2e is restored, the pressure increases in the inside of each of the jet channels C1e, C2e, and therefore, the ink 9 having been induced into the inside of each of the jet channels C1e, C2e is pressurized. Thus, the ink 9 shaped like a droplet is jetted from the nozzle holes H1, H2 toward the outside (the recording paper P).

In this case, for example, since the inner diameter of each of the nozzle holes H1, H2 gradually decreases toward the jet direction as described above, the jet speed of the ink 9 increases, and at the same time, the straightness of the ink 9 is improved. Thus, the quality of the image and so on recorded on the recording paper P is improved.

### <1-5. Functions and Advantages>

Lastly, the functions and the advantages of the printer 1 equipped with the inkjet heads 4 will be described.

### [Principal Functions and Advantages]

In the printer 1, the intermediate plate 42 is disposed between the nozzle plate 41 and the actuator plate 43, and at the same time, the width W2 of each of the slits S provided to the intermediate plate 42 is made larger than the width W1 of each of the channels C provided to the actuator plate 43. Therefore, on the grounds described below, it is possible to obtain an excellent jet characteristic.

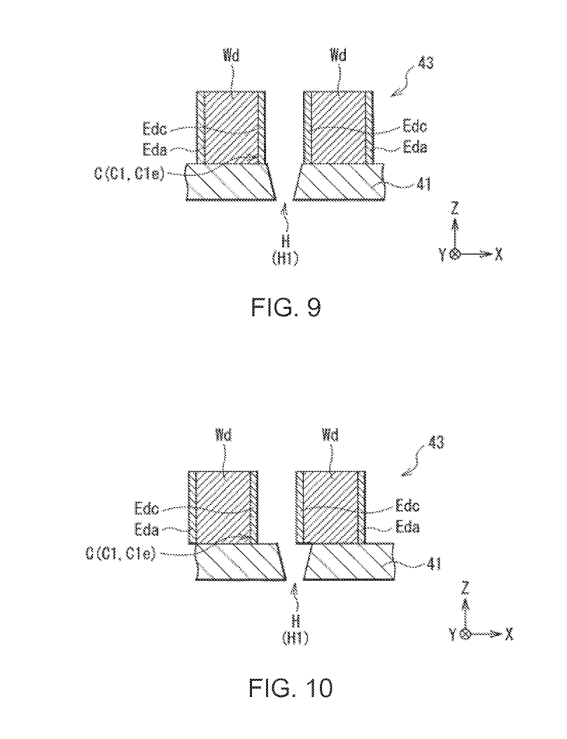

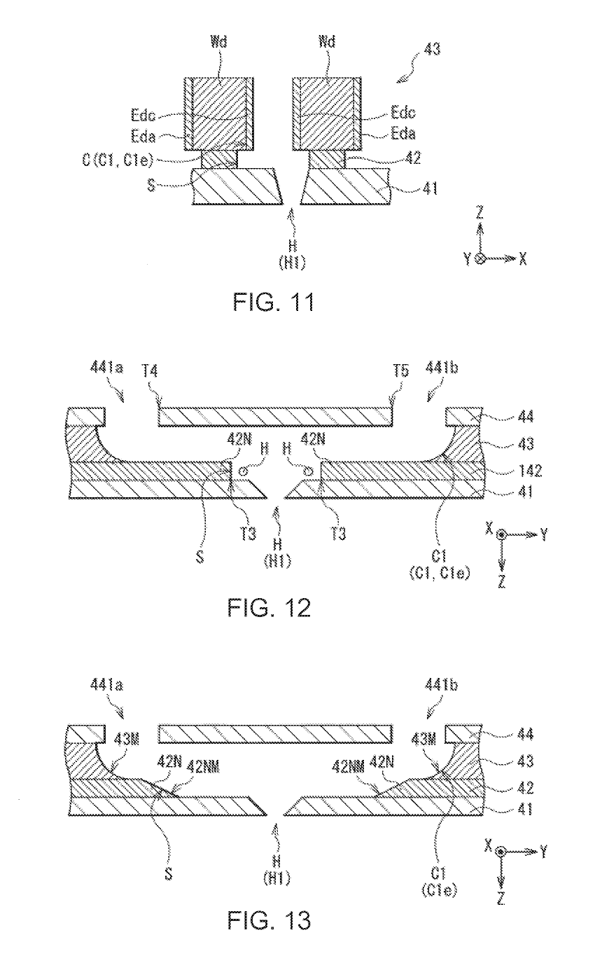

In FIG. 9, a part of respective configurations of the nozzle plate 41 and the actuator plate 43 in a printer (an inkjet head) of a first comparative example is enlarged, and FIG. 9 corresponds to FIG. 7. FIG. 10 shows a cross-sectional configuration corresponding to FIG. 9 in order to explain problems of the printer 1 of the first comparative example described above. FIG. 11 shows a cross-sectional configuration corresponding to FIG. 7 in order to explain the advantages of the printer 1 (the inkjet head 4) according to the present embodiment.

As shown in FIG. 9, the printer of the first comparative example has substantially the same configuration as that of the printer 1 according to the present embodiment except the fact that the intermediate plate 42 is not provided. In this case, the nozzle plate 41 and the actuator plate 43 are bonded to each other.

In the printer of the first comparative example, if the bonding position between the nozzle plate 41 and the actuator plate 43 is shifted in the X-axis direction in the manufacturing process of the inkjet head, the path of the ink 9 from the channel C to the nozzle hole H becomes apt to narrow as shown in FIG. 10. This is because if the bonding position is shifted in the X-axis direction, the drive wall Wd in the actuator plate 43 is apt to be located right above the nozzle hole H, and therefore, the width (the maximum width) of the nozzle hole H is apt to substantively narrow. In this case, since the supply of the ink 9 supplied from the channel C to the nozzle hole H becomes apt to be hindered by the actuator plate 43, the problem related to the jet characteristic of the ink 9 becomes easy to occur. The problem is, for example, the deflection of the jet direction of the ink 9 due to an inhibition of the supply of the ink 9 described above. Therefore, it is difficult to obtain the excellent jet characteristic.

The tendency that the problem occurs in such a manner becomes more conspicuous in particular in the case in which the inner diameter (the nozzle diameter) of the nozzle hole H is increased in size in accordance with the increase in size of the droplet of the ink 9, and the nozzle plate 41 and the actuator plate 43 are bonded to each other with the alignment accuracy before increasing the droplet in size. This is because in this case, the drive wall Wd becomes more apt to be located right above the nozzle hole H, and therefore, the width of the nozzle hole H is apt to become substantively narrower. Further, this is because in this case, since the supply amount of the ink 9 becomes apt to be uneven on the upstream side of the nozzle hole H due to the fact that the drive wall Wd is disposed right above the nozzle hole H, the jet direction of the ink 9 becomes more apt to be deflected.

In contrast, in the printer 1 (the inkjet head 4) according to the present embodiment, the intermediate plate 42 is disposed between the nozzle plate 41 and the actuator plate 43, and the width W2 of each of the slit S is made larger than the width W1 of each of the channels C as shown in FIG. 7. In this case, as shown in FIG. 11, the path of the ink 9 from the channel C to the nozzle hole H becomes difficult to narrow even if the bonding position between the nozzle plate 41 and the actuator plate 43 is shifted in the X-axis direction. This is because even if the bonding position is shifted in the X-axis direction, the drive wall Wd is difficult to be located right above the nozzle hole H, and therefore, the width (the maximum width) of the nozzle hole H is difficult to substantively narrow. Thus, since the supply of the ink 9 supplied from the channel C to the nozzle hole H becomes difficult to be hindered by the actuator plate 43, the problem related to the jet characteristic described above becomes difficult to occur. Therefore, it is possible to obtain the excellent jet characteristic. This advantage can sufficiently be obtained also in the case of increasing the nozzle diameter in size and at the same time bonding the nozzle plate 41 and the actuator plate 43 to each other with the previous alignment accuracy.

### [Other Functions and Advantages]

In particular, in the printer 1 according to the present embodiment, since the inside end parts T2 of the intermediate plate 42 are located on the outer side of the inside end parts T1 of the actuator plate 43, if the channel C is disposed in the area defined by the width W2 of the slit S, it becomes difficult for the supply of the ink 9 to the nozzle hole H to be hindered even if the bonding position between the nozzle plate 41 and the actuator plate 43 is shifted in either direction. Therefore, since supply of the ink 9 to the nozzle hole H is stabilized, a greater advantage can be obtained.

Further, if the intermediate plate 42 has the intermediate linear expansion coefficient E1 between the linear expansion coefficient E2 of the nozzle plate 41 and the linear expansion coefficient E3 of the actuator plate 43, the separation of the nozzle plate 41 and so on due to the thermal deformation is prevented. Therefore, since it becomes difficult for the failure such as deflection to occur when jetting the ink 9, a greater advantage can be obtained.

Further, if the intermediate plate 42 includes an insulating material while the nozzle plate 41 includes a conductive material and the actuator plate 43 includes a piezoelectric material, the nozzle plate 41 and the actuator plate 43 are electrically insulated from each other via the intermediate plate 42. Thus, since it becomes possible to use a metal material or the like having high scratch resistance as the constituent material of the nozzle plate 41, it becomes difficult for the nozzle plate 41 to be damaged (e.g., worn) while preventing the short circuit between the nozzle plate 41 and the actuator plate 43. Therefore, since the jet characteristic of the ink 9 is stabilized, a greater advantage can be obtained.

Further, since the inside end parts T3 of the intermediate plate 42 are located on the outer side of the inside end parts T4, T5 of the cover plate 44, if the slit S extends from the position in the area corresponding to the entrance side common ink chamber 441a to the position in the area corresponding to the exit side common ink chamber 441b, a greater advantage can be obtained on the grounds described below.

FIG. 12 shows respective cross-sectional configurations of the nozzle plate 41, an intermediate plate 142 and the actuator plate 43 in a printer (an inkjet head) of a second comparative example in an enlarged manner, and corresponds to FIG. 8.

As shown in FIG. 12, the printer of the second comparative example has substantially the same configuration as that of the printer 1 (the inkjet head 4) according to the present embodiment except the fact that the intermediate plate 142 is provided instead of the intermediate plate 42. In the printer of the second comparative example, the inside end parts T3 of the intermediate plate 142 are located on the inner side of the inside end parts T4, T5 of the cover plate 44.

When the ink 9 is supplied from the channel C to the nozzle hole H via the slit S, the bubble H becomes apt to occur in the vicinity of each of the inside end parts T3 of the intermediate plate 42. This is because since a step (an angular part 42N) is formed on the nozzle plate 41 in the vicinity of each of the inside end parts T3 of the intermediate plate 42, the ink 9 becomes difficult to flow in the vicinity (an area hidden behind the angular part 42N) of the angular part 42N.

In the printer of the second comparative example provided with the intermediate plate 142, since the inside end parts T3 are located on the inner side of the inside end parts T4, T5, the angular parts 42N are located close to the nozzle hole H as shown in FIG. 12. In this case, if the bubble H is generated in the vicinity of the angular part 42N in the inside of the slit S, the bubble H becomes apt to be retained inside the slit S, and at the same time, becomes apt to be jetted from the nozzle hole H. Thus, it becomes easy for the jet failure of the ink 9 due to the jet of the bubble H to occur when the ink 9 is jetted from the nozzle hole H, and therefore, the jet operation of the ink 9 becomes unstable.

In contrast, in the printer 1 according to the present embodiment provided with the intermediate plate 42, since the inside end parts T3 are located on the outer side of the inside end parts T4, T5, the angular parts 42N are located far from the nozzle hole H as shown in FIG. 8. In this case, even if the bubble H occurs in the vicinity of the angular part 42N in the inside of the slit S, it becomes easy to discharge the bubble H from the exit side common ink chamber 441b using the flow of the ink 9 from the entrance side common ink chamber 441a toward the exit side common ink chamber 441b in the inside of the slit S. Thus, it becomes difficult for the bubble H to be retained inside the slit S, and at the same time, it becomes difficult for the bubble H to be jetted from the nozzle hole H. Therefore, since the jet failure of the ink 9 due to the bubble H becomes difficult to occur, the jet operation of the ink 9 is stabilized, and thus, it is possible to further improve the jet characteristic.

It should be noted that the functions and the advantages related to the printer 1 described above can also be obtained with respect to the inkjet head 4 in a similar manner.

### 2. MODIFIED EXAMPLES

The configuration of the printer 1 (the inkjet head 4) described above can arbitrarily be changed. It should be noted that regarding the series of modified examples described below, any two or more types can also be combined with each other.

### Modified Example 1

Specifically, for example, it is also possible to tilt the angular part 42N so that the thickness gradually decreases in a direction of coming closer to the nozzle hole H as shown in FIG. 13 corresponding to FIG. 8.

The tilt angle defined by the surface of the nozzle plate 41 and the tilted surface 42NM of the angular part 42N can arbitrarily be set. The tilted surface 42NM can be, for example, flat, curved, or bent once or two or more times in the middle. FIG. 13 shows the case in which, for example, the tilted surface 42NM is flat. The position of the tip of the angular part 42N is not particularly limited, and therefore, the tip of the angular part 42N can arbitrarily be disposed.

In this case, since the area hidden behind the angular part 42N, which is an occurrence factor of the bubble H (see FIG. 8), becomes difficult to occur, it becomes fundamentally difficult for the bubble H to occur. Therefore, since the jet operation of the ink 9 is further stabilized, a greater advantage can be obtained.

### Modified Example 2

Besides the above, the types and so on of each of the printer 1 and the inkjet head 4 can arbitrarily be changed. Further, the shape, the layout, the number and so on related to the series of constituents of each of the printer 1 and the inkjet head 4 can arbitrarily be changed.

Specifically, for example, although the two-column type inkjet head 4 having the two nozzle columns 410 (411, 412) has been described, this is not a limitation, and it is also possible to adopt a single column type inkjet head 4 having just one column, or a multi-column type inkjet head 4 having three or more nozzle columns.

Further, for example, although there has been described the case in which each of the nozzle columns 411, 412 extends in the X-axis direction, this is not a limitation, and it is also possible for each of the nozzle columns 411, 412 to extend in an oblique direction with respect to the X-axis direction, or to extend in other directions. It should be noted that, for example, although there has been described the case in which the opening shape of each of the nozzle holes H1, H2 is the circular shape, this is not a limitation, and the opening shape of each of the nozzle holes H1, H2 can also be a roughly circular shape such as an elliptical shape, a polygonal shape such as a triangular shape, or other shapes.

Further, for example, although the channel columns 430 formed of the two channel columns (431, 432) have been described in accordance with the nozzle columns 410 formed of the two nozzle columns (411, 412) described above, this is not a limitation. The number of columns of the channel columns 430 can be one, or three or more in accordance with the number of columns of the nozzle columns 410.

### Modified Example 3

Further, for example, it is also possible to add a variety of mechanisms to the printer 1. Specifically, for example, it is also possible to install a wiping mechanism and so on not shown in the drawings to the printer 1. The wiping mechanism is, for example, a mechanism having a function of removing the ink 9 having adhered to the surface (the nozzle surface) of the nozzle plate 41 provided with the nozzle holes H.

Although the description regarding the present disclosure has been presented hereinabove citing the embodiment, the configuration of the present disclosure is not limited to the configuration explained in the embodiment described above, but a variety of modifications can be adopted.

Specifically, for example, instead of jetting a single color of ink from a single inkjet head, it is also possible for the single inkjet head to jet a plurality of colors (e.g., two colors) of ink different from each other.

Further, for example, the inkjet head is not limited to the ink circulation type inkjet head using the circulation mechanism, but can also be an ink non-circulation type inkjet head not using the circulation mechanism.

Further, for example, the purposes to which each of the liquid jet head and the liquid jet recording device of the present disclosure is applied are not limited to the inkjet printer, but can also be other purposes. The other purposes can also be other devices such as a facsimile or an on-demand printing machine.

It should be noted that the advantages described in the specification are illustrative only but are not a limitation, and other advantages can also be provided.

Further, the present disclosure can also take the following configurations.

<1>

A liquid jet head comprising an actuator plate having a plurality of channels extending in a first direction, the plurality of channels filled with liquid; a nozzle plate disposed so as to be opposed to the actuator plate, and having a plurality of nozzle holes at positions corresponding to the plurality of channels, the liquid filled in the plurality of channels being jetted from the plurality of nozzle holes in a second direction crossing the first direction; and an intermediate plate disposed between the actuator plate and the nozzle plate, and having a plurality of slits extending in the first direction at positions corresponding respectively to the plurality of channels and the plurality of nozzle holes, a width of each of the plurality of slits in a third direction crossing each of the first direction and the second direction being larger than a width of each of the plurality of channels in the third direction.

<2>

The liquid jet head according to <1>, wherein the actuator plate has two first inside end parts adapted to define one of the plurality of channels in the third direction, and the intermediate plate has two second inside end parts adapted to define one of the plurality of slits in the third direction, and each of the two second inside end parts is located on an outer side of each of the two first inside end parts in the third direction.

<3>

The liquid jet head according to <1> or <2>, wherein the intermediate plate has an intermediate linear expansion coefficient between a linear expansion coefficient of the actuator plate and a linear expansion coefficient of the nozzle plate.

<4>

The liquid jet head according to any one of <1> to <3>, wherein each of the actuator plate and the nozzle plate includes a conductive material, and the intermediate plate includes an insulating material.

<5>

The liquid jet head according to any one of <1> to <4>, further comprising a cover plate disposed so as to be opposed to the actuator plate, and having an introduction opening which is disposed at a position corresponding to one end part of the channel in the first direction and through which the liquid is introduced into the channel, and a discharge opening which is disposed at a position corresponding to the other end part of the channel in the first direction and through which the liquid having been introduced from the introduction opening is discharged, wherein the actuator plate is disposed between the intermediate plate and the cover plate, the intermediate plate has two third inside end parts adapted to define one of the plurality of slits in the first direction, the cover plate has a fourth inside end part adapted to define the introduction opening in the first direction, and a fifth inside end part adapted to define the discharge opening in the first direction, and each of the two third inside end parts is located on an outer side of each of the fourth inside end part and the fifth inside end part in the first direction.

<6>

A liquid jet recording device comprising the liquid jet head according to any one of <1> to <5>, and adapted to jet the liquid to a recording target medium; and a liquid storage section adapted to store the liquid.

What is claimed is:

1. A liquid jet head comprising:
an actuator plate having a plurality of channels extending in a first direction, the plurality of channels filled with liquid;
a nozzle plate disposed so as to be opposed to the actuator plate, and having a plurality of nozzle holes at positions corresponding to the plurality of channels, the liquid filled in the plurality of channels being jetted from the plurality of nozzle holes in a second direction crossing the first direction; and
an intermediate plate disposed between the actuator plate and the nozzle plate, and having a plurality of slits extending in the first direction at positions corresponding respectively to the plurality of channels and the plurality of nozzle holes, a width of each of the plurality of slits in a third direction crossing each of the first direction and the second direction being larger than a width of each of the plurality of channels in the third direction.

2. The liquid jet head according to claim 1, wherein
the actuator plate has two first inside end parts adapted to define one of the plurality of channels in the third direction, and the intermediate plate has two second inside end parts adapted to define one of the plurality of slits in the third direction, and
each of the two second inside end parts is located on an outer side of each of the two first inside end parts in the third direction.

3. The liquid jet head according to claim 1, wherein
the intermediate plate has an intermediate linear expansion coefficient between a linear expansion coefficient of the actuator plate and a linear expansion coefficient of the nozzle plate.

4. The liquid jet head according to claim 1, wherein
each of the actuator plate and the nozzle plate includes a conductive material, and
the intermediate plate includes an insulating material.

5. The liquid jet head according to claim 1, further comprising a cover plate disposed so as to be opposed to the actuator plate, and having an introduction opening which is disposed at a position corresponding to one end part of the channel in the first direction and through which the liquid is introduced into the channel, and a discharge opening which is disposed at a position corresponding to the other end part of the channel in the first direction and through which the liquid having been introduced from the introduction opening is discharged,
wherein the actuator plate is disposed between the intermediate plate and the cover plate,
the intermediate plate has two third inside end parts adapted to define one of the plurality of slits in the first direction,
the cover plate has a fourth inside end part adapted to define the introduction opening in the first direction, and a fifth inside end part adapted to define the discharge opening in the first direction, and
each of the two third inside end parts is located on an outer side of each of the fourth inside end part and the fifth inside end part in the first direction.

6. A liquid jet recording device comprising:
the liquid jet head according to claim 1, and adapted to jet the liquid to a recording target medium; and
a liquid storage section adapted to store the liquid.
